(19) United States
(12) Patent Application Publication
(10) Pub. No.: US 2024/0363995 A1
(43) Pub. Date: Oct. 31, 2024

(54) MICROELECTRONIC ASSEMBLIES WITH INTEGRATED GLASS-BASED ANTENNA UNITS

(71) Applicant: Intel Corporation, Santa Clara, CA (US)

(72) Inventors: Bai Nie, Chandler, AZ (US); Jeremy Ecton, Gilbert, AZ (US); Brandon C. Marin, Gilbert, AZ (US); Mohammad Mamunur Rahman, Gilbert, AZ (US)

(73) Assignee: Intel Corporation, Santa Clara, CA (US)

(21) Appl. No.: 18/306,399

(22) Filed: Apr. 25, 2023

(51) Int. Cl. H01Q 1/22; G06F 1/16

(52) U.S. Cl. CPC H01Q 1/2283; G06F 1/1698

(57) ABSTRACT

Disclosed herein are antenna units, microelectronic assemblies, and communication devices that may enable RF chip-to-chip communications in a compact form factor. An example microelectronic assembly may include a microelectronic component (e.g., a package substrate, a circuit board, and interposer, or a die) and an antenna unit that may be separately fabricated and integrated in a recess in the microelectronic component, enabling increased degrees of design freedom and improved yield. An example antenna unit may include a glass core having a first face and an opposing second face, a tapered opening extending between the first face and the second face of the glass core, and a layer of an electrically conductive material on sidewalls of the opening, where the opening in the glass core lined with the layer of the electrically conductive material forms a horn antenna integrated in the glass core.

### BACKGROUND

In context of a wireless communication system, an antenna is a device that serves as the interface between electromagnetic waves propagating wirelessly through space and electric currents moving in metal conductors used with a transmitter or a receiver of a wireless communication device. During transmission, a transmitter supplies an electric current to the antenna's terminals, and the antenna radiates the energy from the current as electromagnetic waves. During reception, an antenna intercepts some of the power of an electromagnetic wave in order to produce an electric current at its terminals, which current is subsequently applied to a receiver to be amplified.

Radio frequency (RF) wireless communication in the form of electromagnetic waves in a frequency range of approximately 3 kiloHertz (kHz) to 300 gigaHertz (GHz) and beyond is becoming more and more important for over-the-air chip-to-chip data transfer due to its potential to provide advantages over conventional communication means such as interconnects or electrical cables/wires. For example, RF wireless chip-to-chip communication may advantageously coexist with other technologies such as embedded multi-die interconnect bridge (EMIB) or on-die interconnect (ODI) for both short-range as well as medium-range communication. In such communication links, a digital signal to be communicated is modulated over an RF carrier and transmitted over free space or any dielectric medium using an antenna. When the RF carrier is a signal of a sufficiently high frequency (e.g., a signal with a frequency in millimeter-wave, sub-terahertz (sub-THz), and terahertz (THz) regions), the wavelength of the RF carrier may be so small that antenna dimensions become small enough to make integration of antennas directly on-chip or in an integrated circuit (IC) package a very attractive option. However, integration of small antenna units on-chip or in a package is not trivial and is often associated with its own challenges such as narrow bandwidth or low gain.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIGS. 1-2 are side, cross-sectional views of example microelectronic assemblies with integrated glass-based antenna units, in accordance with various embodiments.

FIGS. 3-7 are side, cross-sectional views of example stages in the manufacture of glass-based horn antenna units, in accordance with various embodiments.

FIGS. 8-9 are side, cross-sectional views of example microelectronic assemblies with integrated glass-based horn antenna units, in accordance with various embodiments.

FIG. 10 is a perspective view of a handheld communication device including an IC package with one or more microelectronic assemblies with integrated glass-based antenna units, in accordance with various embodiments.

FIG. 11 is a perspective view of a laptop communication device including multiple IC packages with one or more microelectronic assemblies with integrated glass-based antenna units, in accordance with various embodiments.

FIG. 12 is a top view of a wafer and dies that may be included in microelectronic assemblies with integrated glass-based antenna units in accordance with any of the embodiments disclosed herein.

FIG. 13 is a side, cross-sectional view of an IC device that may include one or more microelectronic assemblies with integrated glass-based antenna units in accordance with any of the embodiments disclosed herein.

FIG. 14 is a side, cross-sectional view of an IC device assembly that may include one or more microelectronic assemblies with integrated glass-based antenna units in accordance with any of the embodiments disclosed herein.

FIG. 15 is a block diagram of an example communication device that may include one or more microelectronic assemblies with integrated glass-based antenna units in accordance with any of the embodiments disclosed herein.

FIG. 16 is a block diagram of an example RF device that may include one or more microelectronic assemblies with integrated glass-based antenna units in accordance with any of the embodiments disclosed herein.

### DETAILED DESCRIPTION

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

For purposes of illustrating microelectronic assemblies with integrated glass-based horn antenna units, proposed herein, it might be useful to first understand phenomena that may come into play in some systems where integrated antenna units may be used. The following foundational information may be viewed as a basis from which the present disclosure may be properly explained. Such information is offered for purposes of explanation only and, accordingly, should not be construed in any way to limit the broad scope of the present disclosure and its potential applications.

As described above, integrating antennas directly on-chip or in a package with circuitry that may need to communicate data with other circuitry is an attractive option for RF wireless chip-to-chip communication. However, integration of small antenna units on-chip or in a package is not trivial and is associated with its own challenges such as narrow bandwidth and low gain. For example, most antennas used for RF communications at frequencies that are high enough to make antenna dimensions small are microstrip-based antennas such as patch antennas. Advantageously, these antennas are usually omni-directional. However, they often exhibit both narrow bandwidth and low gain. The gain may be increased by using a phased array of patch antennas, where multiple antennas radiate simultaneously to form either a fixed beam or a steerable beam. In some scenarios, design, control, and fabrication of phased arrays may be too complicated and costly to make patch antennas viable candidates for point-to-point communication such as RF wireless chip-to-chip communication.

To overcome the challenges associated with patch antennas, horn antennas have been considered for fixed beam point-to-point transmission because they can be designed to exhibit higher gain. For example, horn antennas have been integrated in low-temperature co-fired ceramic (LTCC) packages and in printed circuit board (PCB) substrates. However, such approaches are limited in terms of package design and dielectric materials used and, for LTCC packages, demand multiple LTCC layers, making final packages expensive and low yield, as well as unbalanced in their metal density and dielectric thickness.

Disclosed herein are antenna units, microelectronic assemblies, and communication devices that may enable RF (e.g., millimeter-wave) chip-to-chip communications in a compact form factor. In one aspect of the present disclosure, an example microelectronic assembly may include a microelectronic component (e.g., a package substrate, a circuit board, and interposer, or a die) and an antenna unit that may be separately fabricated and integrated in a recess in the microelectronic component, enabling increased degrees of design freedom and improved yield. An example antenna unit may include a glass core having a first face and an opposing second face, a tapered opening extending between the first face and the second face of the glass core (e.g., a width of the opening at the first face of the glass core may be larger than a width of the opening at the second face of the glass core), and a layer of an electrically conductive material on sidewalls of the opening, where the opening in the glass core lined with the layer of the electrically conductive material forms a horn antenna integrated in the glass core. Such antenna units are referred to as “glass-based horn antenna units” or, simply, as “glass-based horn antennas.” Various ones of the antenna units disclosed herein may exhibit little to no warpage during operation or installation, ease of assembly, low cost, fast time to market, good mechanical handling, and/or good thermal performance. Various ones of the microelectronic assemblies disclosed herein may allow different antennas and/or microelectronic components to be swapped into an existing IC package.

As used herein, the term “glass core” refers to a structure (e.g., a portion of a glass layer) of any glass material such as quartz, silica, fused silica, silicate glass (e.g., boro-silicate glass or alumo-silicate glass), soda-lime glass, soda-lime silica, borofloat glass, lead borate glass, photosensitive glass, non-photosensitive glass, or ceramic glass. In context of the present disclosure, the glass core refers to bulk glass or a solid volume of glass, as opposed to, e.g., materials that may include particles of glass, such as glass fiber reinforced polymers. Such glass materials are typically non-crystalline, often transparent, amorphous solids. However, in some embodiments, what is described herein as a glass core may include solid materials other than glass, e.g., mica, as long as those materials have sufficiently low dielectric constants, e.g., lower than that of silicon (i.e., lower than about 11). In some embodiments, a glass core may include a material, e.g., any of the materials described above, with a weight percentage of silicon being at least about 0.5%, e.g., between about 0.5% and 50%, or between about 1% and 48%. For example, if a glass core is fused silica, the weight percentage of silicon may be about 47%.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Any of the features discussed with reference to any of accompanying drawings herein may be combined with any other features to form a microelectronic assembly with one or more integrated glass-based horn antenna units, as appropriate. A number of elements of the drawings are shared with others of the drawings; for ease of discussion, a description of these elements is not repeated, and these elements may take the form of any of the embodiments disclosed herein. If multiple instances of certain elements are illustrated, then, in some cases, to not clutter the drawings only some of these elements may be labeled with a reference sign and other ones of these elements are not labeled. However, in other cases, for ease of explanation, different instances of a given element in a single drawing may be referred to with numbers 1, 2, and so on, after a dash (e.g., for example, some of the drawings illustrate multiple openings 140 in a glass core of glass-based horn antenna units, the multiple openings 140 labeled individually as openings 140-1, 140-2, etc.).

The drawings are not necessarily to scale. Although many of the drawings illustrate rectilinear structures with flat walls and right-angle corners, this is simply for ease of illustration and may not reflect real-life process limitations which may cause various features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication. Inspection of layout and mask data and reverse engineering of parts of a device to reconstruct the circuit using e.g., optical microscopy, TEM, or SEM, and/or inspection of a cross-section of a device to detect the shape and the location of various device elements described herein using, e.g., Physical Failure Analysis (PFA) would allow determination of presence of microelectronic assemblies with integrated glass-based horn antenna units as described herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used to describe a range of dimensions, the phrase “between X and Y” represents a range that includes X and Y. When used to describe a location of an element, the phrase “between X and Y” represents a region that is spatially between element X and element Y. The terms “substantially,” “close,” “approximately,” “near,” and “about,” generally refer to being within +/−20%, e.g., within +/−5% or within +/−2%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−20%, e.g., within +/−5% or within +/−2%, of a target value based on the context of a particular value as described herein or as known in the art.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. As used herein, the terms “package” and “IC package” are synonymous, as are the terms “die” and “IC die,” and the terms “antenna” and “antenna unit.” Furthermore, the terms “chip,” “chiplet,” “die,” and “IC die” may be used interchangeably herein.

Although certain elements may be referred to in the singular herein, such elements may include multiple sub-elements. For example, “a dielectric material” may include one or more dielectric materials. The terms “oxide,” “carbide,” “nitride,” etc. refer to compounds containing, respectively, oxygen, carbon, nitrogen, etc. The term “high-k dielectric” refers to a material having a higher dielectric constant than silicon oxide, while the term “low-k dielectric” refers to a material having a lower dielectric constant than silicon oxide. The term “insulating” and variations thereof (e.g., “insulative” or “insulator”) means “electrically insulating,” the term “conducting” and variations thereof (e.g., “conductive” or “conductor”) means “electrically conducting,” unless otherwise specified. With reference to optical signals and/or devices, components and elements that operate on or using optical signals, the term “conducting” can also mean “optically conducting.” The term “insulating material” refers to solid materials (and/or liquid materials that solidify after processing as described herein) that are substantially electrically nonconducting. They may include, as examples and not as limitations, organic polymers and plastics, and inorganic materials such as ionic crystals, porcelain, glass, silicon and alumina or a combination thereof. They may include dielectric materials, high polarizability materials, and/or piezoelectric materials. They may be transparent or opaque without departing from the scope of the present disclosure. Further examples of insulating materials are underfills and molds or mold-like materials used in packaging applications, including for example, materials used in organic interposers, package supports and other such components. The term “conductive contact” may refer to a portion of conductive material (e.g., metal) serving as an electrical interface between different components; conductive contacts may be recessed in, flush with, or extending away from a surface of a component, and may take any suitable form (e.g., a conductive pad or socket, or portion of a conductive line or via).

The term “package substrate” may be used to describe any substrate material that facilitates the packaging together of any collection of semiconductor dies and/or other electrical components such as passive electrical components. As used herein, a package substrate may be formed of any material including, but not limited to, insulating materials such as resin impregnated glass fibers (e.g., a PCB or Printed Wiring Boards (PWB)), glass, ceramic, silicon, silicon carbide, etc. In addition, as used herein, a package substrate may refer to a substrate that includes buildup layers (e.g., Ajinomoto Buildup Film (ABF) layers). In some embodiments, a package substrate may be a PCB or a multilayer package substrate that includes a core including glass, e.g., a core including a glass layer, where the glass layer may be bulk glass or a solid volume of glass, as opposed to, e.g., glass fiber reinforced polymers (i.e., in some embodiments, the glass layer does not include any glass fiber reinforced polymers).

In a general sense, an “interconnect” refers to any element that provides a physical connection between two other elements. For example, an electrical interconnect provides electrical connectivity between two electrical components, facilitating communication of electrical signals between them; an optical interconnect provides optical connectivity between two optical components, facilitating communication of optical signals between them. As used herein, both electrical interconnects and optical interconnects are comprised in the term “interconnect.” The nature of the interconnect being described is to be understood herein with reference to the signal medium associated therewith. Thus, when used with reference to an electronic device, such as an IC that operates using electrical signals, the term “interconnect” describes any element formed of an electrically conductive material for providing electrical connectivity to one or more elements associated with the IC or/and between various such elements. In such cases, the term “interconnect” may refer to both conductive traces (also sometimes referred to as “lines,” “wires,” “metal lines” or “trenches”) and conductive vias (also sometimes referred to as “vias” or “metal vias”). Sometimes, electrically conductive traces and vias may be referred to as “conductive traces” and “conductive vias”, respectively, to highlight the fact that these elements include electrically conductive materials such as metals. Likewise, when used with reference to a device that operates on optical signals as well, such as a photonic IC (PIC), “interconnect” may also describe any element formed of a material that is optically conductive for providing optical connectivity to one or more elements associated with the PCI. In such cases, the term “interconnect” may refer to optical waveguides (e.g., structures that guide and confine light waves), including optical fiber, optical splitters, optical combiners, optical couplers, and optical vias.

The term “metallization stack” may be used to refer to a stack of one or more interconnects for providing connectivity to different circuit components of an IC die/chip and/or a package substrate. The term “conductive trace” may be used to describe an electrically conductive element isolated by an insulating material. Within IC dies, such insulating material comprises interlayer low-k dielectric that is provided within the IC die. Within package substrates, and PCBs such insulating material may comprise organic materials such as ABF, polyimides, or epoxy resin. Such conductive lines are typically arranged in several levels, or several layers, of metallization stacks. The term “conductive via” may be used to describe an electrically conductive element that interconnects two or more conductive lines of different levels of a metallization stack. To that end, a via may be provided substantially perpendicularly to the plane of an IC die/chip or a support structure over which an IC structure is provided and may interconnect two conductive lines in adjacent levels or two conductive lines in non-adjacent levels.

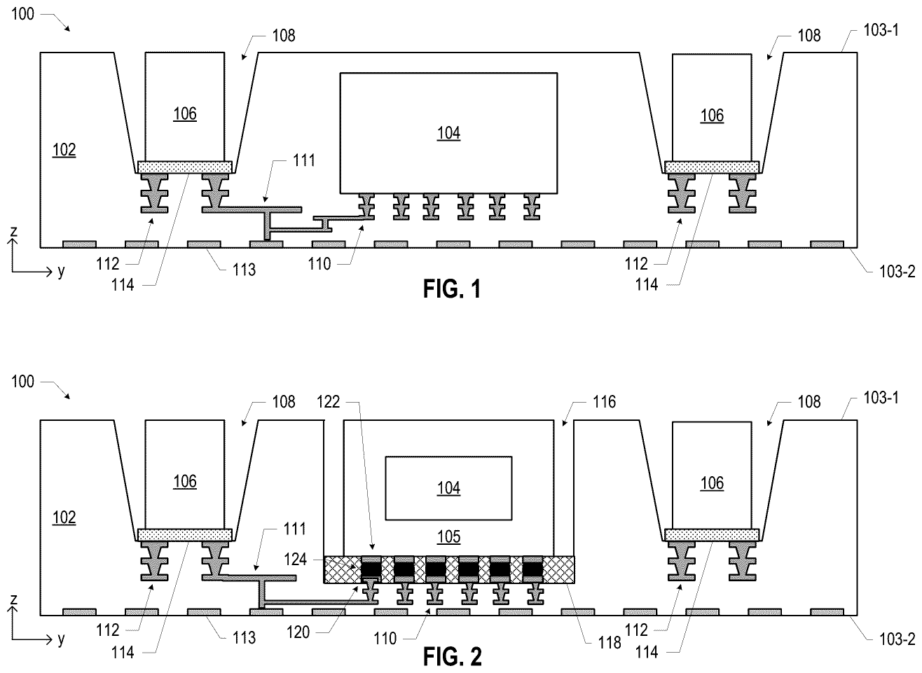

FIG. 1 is a side, cross-sectional view of a microelectronic assembly 100, in accordance with some embodiments. The microelectronic assembly 100 may include a microelectronic component 102, which may be a package substrate, a circuit board, an interposer, a die, etc., circuitry 104 that may need to communicate wirelessly with circuitry in another assembly nearby, and one or more antenna units 106 to enable such communication. The microelectronic component 102 may include a first face 103-1 and a second face 103-2, opposite the first face 103-1, and the antenna units 106 may be provided in one or more recesses 108 at the first face 103-1. Although a single circuitry 104 is illustrated in FIG. 1 (and others of the accompanying drawings), this is simply illustrative, and a microelectronic assembly 100 may include more than one instance of the circuitry 104 that may need to communicate wirelessly using one or more antenna units 106. Similarly, although two antenna units 106 are illustrated in FIG. 1 (and others of the accompanying drawings), this is simply illustrative, and a microelectronic assembly 100 may include fewer or more antenna units 106 integrated in the microelectronic component 102. For example, a microelectronic component 102 may include four antenna units 106 (e.g., arranged in a linear array), eight antenna units 106 (e.g., arranged in one linear array, or two linear arrays), sixteen antenna units 106 (e.g., arranged in a 4×4 array), or thirty-two antenna units 106 (e.g., arranged in two 4×4 arrays).

In some embodiments, a microelectronic assembly 100 may include one or more arrays of antenna units 106 to support multiple communication bands (e.g., dual band operation or tri-band operation). For example, some of the antenna units 106 disclosed herein may support tri-band operation at 28 gigahertz, 39 gigahertz, and 60 gigahertz. Various ones of the antenna units 106 disclosed herein may support tri-band operation at 24.5 gigahertz to 29 gigahertz, 37 gigahertz to 43 gigahertz, and 57 gigahertz to 71 gigahertz. Various ones of the antenna units 106 disclosed herein may support 5G communications and 60 gigahertz communications. Various ones of the antenna units 106 disclosed herein may support 28 gigahertz and 39 gigahertz communications. Various of the antenna units 106 disclosed herein may support millimeter-wave communications. Various of the antenna units 106 disclosed herein may support high band frequencies and low band frequencies.

The microelectronic component 102 may include interconnects such as conductive pathways (e.g., provided by conductive vias and lines through one or more dielectric materials) and RF transmission structures (e.g., antenna feed structures, such as striplines, microstriplines, or coplanar waveguides) that may enable one or more antenna units 106 to transmit and receive electromagnetic waves under the control of the circuitry 104 in the microelectronic assembly 100. FIG. 1 schematically illustrates that the microelectronic component 102 includes interconnects 110 coupled to the circuitry 104 and interconnects 112 coupled to the antenna units 106. The interconnects 110 and 112 may be coupled to (e.g., be in conductive contact with) one another, e.g., via interconnects 111, so that signals may be exchanged between the circuitry 104 and one or more antenna units 106. In some embodiments, any of the interconnects 110, 111, 112 may extend through the microelectronic component 102 to conductive contacts 113 at the bottom of the microelectronic component 102 (where the “bottom” may be the face opposite the face in which recesses 108 for the antenna units 106 are provided). The conductive contacts 113 may ensure that power, ground, and/or signals may be routed to/from circuitry 104 and/or antenna units 106 integrated with the microelectronic component 102. The interconnects 110, 111, 112 may have any suitable geometry and configuration and may differ from what is shown as an example in FIG. 1. The interconnects 110, 111, 112 may include traces, vias, and other structures, as known in the art, formed of an electrically conductive material (e.g., a metal, such as copper, silver, nickel, gold, aluminum, titanium, tantalum, or other metals or alloys, for example). The interconnects 110, 111, 112 may be bordered by liner materials, such as adhesion liners and/or barrier liners, as suitable. Different ones of the interconnects 110, 111, 112 in the microelectronic component 102 may be electrically insulated from each other by an insulating material of the microelectronic component 102. In some embodiments, the insulating material of a microelectronic component 102 may include a dielectric material, such as silicon dioxide, silicon nitride, oxynitride, polyimide materials, glass reinforced epoxy matrix materials, or a low-k or ultra low-k dielectric (e.g., carbon-doped dielectrics, fluorine-doped dielectrics, porous dielectrics, organic polymeric dielectrics, photo-imageable dielectrics, and/or benzocyclobutene-based polymers). In some embodiments, the insulating material of a microelectronic component 102 may include a semiconductor material, such as silicon, germanium, or a III-V material (e.g., gallium nitride), and one or more additional materials. For example, an insulating material may include silicon oxide or silicon nitride. In some embodiments, the insulating material of a microelectronic component 102 may include a laminate material, an organic dielectric material, a fire retardant grade 4 material (FR-4), or bismaleimide triazine (BT) resin.

As further shown in FIG. 1, a bonding layer 114 may be provided at the bottom of the recesses 108. In some embodiments, the bonding layer 114 may include a conductive material to ensure that electrically conductive material of an antenna unit 106 is electrically connected to the interconnects 112 coupled to that antenna unit 106 as well as to ensure that the antenna unit 106 is mechanically attached to the bottom of the recess 108. In such embodiments, the electrically conductive material of the antenna unit 106 may be in conductive contact with the bonding layer 114 and the bonding layer 114 may be in conductive contact with the interconnects 112 coupled to that antenna unit 106. In other embodiments, the bonding layer 114 may include a non-conductive material to ensure that the antenna unit 106 is mechanically attached to the bottom of the recess 108, and electrical connectivity of the electrically conductive material of an antenna unit 106 to the interconnects 112 coupled to that antenna unit 106 may be realized by virtue of conductive pathways (e.g., conductive vias) through the non-conductive material of the bonding layer 114 (such conductive pathways through the bonding layer 114 is not specifically shown in FIG. 1). In such embodiments, the bonding layer 114 may include any suitable adhesive material such as epoxy, and the electrically conductive material of the antenna unit 106 may be in conductive contact with the conductive pathways in the bonding layer 114 and the conductive pathways of the bonding layer 114 may be in conductive contact with the interconnects 112 coupled to that antenna unit 106. The thickness of the bonding layer 114 may control the distance between the antenna units 106 and the proximate face of the microelectronic component 102 (e.g., the distance between the antenna units 106 and the bottom of the recesses 108).

FIG. 1 illustrates an embodiment where circuitry 104 is monolithically integrated within the microelectronic component 102. On the other hand, FIG. 2 illustrates a microelectronic assembly 100 similar to that of FIG. 1, except that circuitry 104 is provided in a recess 116 in the microelectronic component 102. In some such embodiments, circuitry 104 may be coupled to a microelectronic component 102 by solder. To that end, FIG. 2 illustrates a solder resist 118, conductive contacts 120 at a face of the microelectronic component 102 to which the circuitry 104 is coupled (e.g., conductive contacts 120 at the bottom of the recess 116), and conductive contacts 122 at a face of the circuitry 104 that is coupled to the microelectronic component 102 (e.g., conductive contacts 122 at the bottom of the circuitry 104, opposite the conductive contacts 120 of the microelectronic component 102). In such embodiments, the circuitry 104 may be secured to the microelectronic component 102 by solder 124 (or other second-level interconnects) between conductive contacts 120 of the microelectronic component 102 and the conductive contacts 122 of the circuitry 104. The height of the solder 124 (or other interconnects) may control the distance between the circuitry 104 and the proximate face of the microelectronic component 102. In some embodiments, the conductive contacts 120/solder 124/conductive contacts 122 may provide an electrically conductive material pathway through which signals may be transmitted to or from the circuitry 104 and the microelectronic component 102. As used herein, a “conductive contact” may refer to a portion of conductive material (e.g., metal) serving as an interface between different components; conductive contacts may be recessed in, flush with, or extending away from a surface of a component, and may take any suitable form (e.g., a conductive pad or socket). Any of the conductive contacts disclosed herein (e.g., the conductive contacts 113, 120, and/or 122) may include bond pads, posts, or any other suitable conductive contact, for example.

FIG. 2 illustrates an embodiment where circuitry 104 is provided in a die 105 arranged in a recess 116 at the same face of the microelectronic component 102 as the antenna units 106 (i.e., in the first face 103-1). However, in other embodiments, the die 105 with circuitry 104 may be provided in a similar recess in the opposite face, e.g., in the second face 103-2. In some embodiments, the top of the die 105 with circuitry 104 provided in a recess 116 may be aligned with the top of the recess 116 (i.e., aligned with the face of the microelectronic component 102 in which the recess 116 is provided), as illustrated in FIG. 2. However, this need not be the case in other embodiments, where the die 105 may extend beyond the recess 116 or be below the top of the recess 116. Analogous applies to the antenna units 106: in some embodiments, the top of an antenna unit 106 provided in a recess 108 may be aligned with the top of the recess 108 (i.e., aligned with the face of the microelectronic component 102 in which the recess 108 is provided), as illustrated in FIG. 1 and FIG. 2; however, this need not be the case in other embodiments, where the antenna units 106 may extend beyond the recess 108 or be below the top of the recess 108. Thus, more generally, the antenna units 106 may be at least partially in the recesses 108. Any of the recesses 108, 116 may have any suitable dimensions for accommodating the antenna units 106 and the dies 105 as needed. For example, in some embodiments, a depth of a recess 108 (a dimension measured along the z-axis of the example coordinate system shown) may be between about 10 microns and 500 microns, including all values and ranges therein. In some embodiments, the recesses 108, 116 may be formed by laser drilling.

In some embodiments, the microelectronic component 102 may be a lower density medium and the circuitry 104 may be a higher density medium. As used herein, the term “lower density” and “higher density” are relative terms indicating that the conductive pathways (e.g., including conductive lines and conductive vias) in a lower density medium are larger and/or have a greater pitch than the conductive pathways in a higher density medium. In some embodiments, a higher density medium may be manufactured using a modified semi-additive process or a semi-additive buildup process with advanced lithography (with small vertical interconnect features formed by advanced laser or lithography processes), while a lower density medium may be a PCB manufactured using a standard PCB process (e.g., a standard subtractive process using etch chemistry to remove areas of unwanted copper, and with coarse vertical interconnect features formed by a standard laser process).

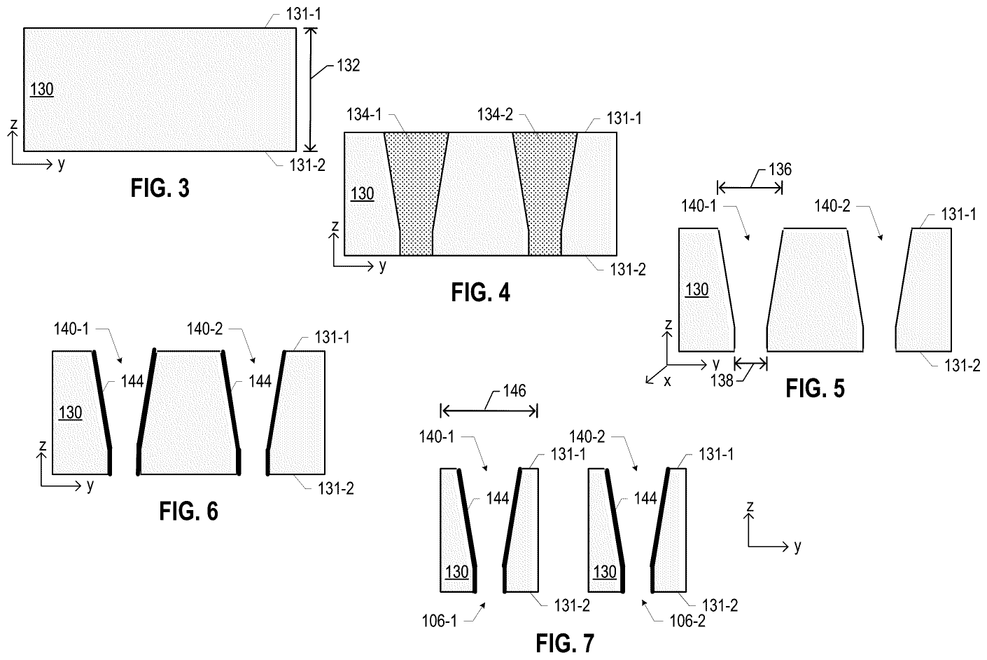

FIGS. 3-7 are side, cross-sectional views of example stages in the manufacture of glass-based horn antenna units, in accordance with various embodiments. Although the operations discussed with reference to FIGS. 3-7 may be illustrated with reference to particular embodiments of the antenna units 106 disclosed herein, the manufacturing methods discussed with reference to FIGS. 3-7 may be used to form any suitable antenna units 106. Operations are illustrated once each and in a particular order in FIGS. 3-7, but the operations may be reordered and/or repeated as desired (e.g., with different operations performed in parallel when manufacturing multiple antenna units 106 simultaneously). In other embodiments, any other suitable manufacturing processes may be used to manufacture any of the antenna units 106 disclosed herein.

FIG. 3 illustrates that manufacture of glass-based horn antenna units 106 may start by providing a glass core 130 having a first face 131-1, and an opposing second face 131-2. The glass core 130 may include any type of a glass material as described above or solid materials other than glass, e.g., mica, as long as those materials have sufficiently low dielectric constants, e.g., lower than that of silicon. In some embodiments, the glass core 130 may include ions, e.g., sodium or boron, to modulate mechanical or electrical properties of the glass core 130. If used, concentration of such ions in the glass core 130 may be at least 1015 ions per cubic centimeter. In some embodiments, a dimension 132 of the glass core in a plane perpendicular to the first face of the glass core (i.e., the height of the glass core) may be between about 50 microns and 2000 microns, including all values and ranges therein, e.g., between about 100 and 1000 microns or between about 100 and 750 microns.

FIG. 4 illustrates that the glass core 130 may then be inscribed to define regions 134 specifying locations, dimensions, and geometry (specifying contours) of future horn antennas. In particular, the inscribed regions 134 define the openings that will be formed in the glass core 130 before the inner walls of the openings are covered with an electrically conductive material. FIG. 4 illustrates two inscribed regions 134, labeled as a first inscribed region 134-1 and a second inscribed region 134-2, formed in a single glass core 130, for an example of two glass-based horn antenna units being fabricated in the glass core 130. In some embodiments, the inscribed regions 134 may be defined using a laser, e.g., an ultrafast laser such as a laser in femtosecond to picosecond range. As used herein, laser inscription refers to modification of a surface of the glass core 130 (a side surface in this example, as shown in FIG. 4) in a way that ensures that, when the glass core 130 is etched in a subsequent process, to form openings for the horn antennas, the volume modified by the laser inscription will have a much faster etch rate than the unmodified region, e.g. about 500 times faster, or about 1000 times faster, which may allow fabricating three-dimensional openings with very high aspect ratios.

FIG. 5 illustrates that, once the regions 134 have been inscribed, the glass core 130 may be etched using any suitable etch process, such as a wet etch. Because the inscription ensures that the etch process starting from the inscribed regions 134 goes much faster than the unmodified portions of the glass core 130, the etch may result in formation of openings 140, labeled in FIG. 5 as a first opening 140-1 and a second opening 140-2. The openings 140 start from the side of the glass core 130 on which the regions 134 were inscribed (i.e., starting from the y-z plane of FIG. 4) and extend along the x-axis direction of the example x-y-z coordinate system shown in FIG. 5 (and some of the other drawings). For a horn antenna, a width 136 of an opening 140 at the first face 131-1 of the glass core 130 may be larger than a width 138 of an opening 140 at the second face 131-2 of the glass core 130, where the width may be a dimension measured along the y-axis of the example coordinate system shown. For example, in some embodiments a width 136 of an opening 140 at the first face 131-1 of the glass core 130 may be between about 50 microns and 2000 microns, including all values and ranges therein, e.g., between about 100 and 1000 microns or between about 100 and 750 microns. In some embodiments, a width 138 of an opening 140 at the second face 131-2 of the glass core 130 may be between about 10 microns and 200 microns, including all values and ranges therein, e.g., between about 10 and 100 microns or between about 10 and 75 microns. In some embodiments, a length of an opening 140 (i.e., a dimension of the opening 140 measured in a direction parallel to the x-axis of the example coordinate system shown) may be between about 30 and 600 microns or between about 30 and 250 microns. In other embodiments, a length of an opening 140 may be about the same as the width 138 or may be about 2 times smaller or greater than the width 138. For example, the opening 140 may have a substantially rectangular (e.g., square) or an elliptical (e.g., circular) cross-section in an x-y plane. In some embodiments, a ratio of the length of the opening 140 to the smallest width of the opening 140 (e.g., to the width 138) may be at least 1, e.g., between about 1 and 50 or between about 1 and 20.

FIG. 6 illustrates that sidewalls of the openings 140 may then be lined with a layer of an electrically conductive material 144, e.g., a metal, such as copper, silver, nickel, gold, aluminum, or other metals or alloys. The electrically conductive material 144 may be deposited on sidewalls of the openings 140 using any suitable conformal deposition technique, such as atomic layer deposition (ALD), chemical vapor deposition (CVD), plasma enhanced CVD (PECVD), or physical vapor deposition (PVD) processes such as sputter. In some embodiments, the layer of an electrically conductive material 144 may have a thickness between about 1 nanometer and 20 micron, including all values and ranges therein, e.g., between about 1 nanometer and 10 micron, or between about 1 and 50 nanometers.

An opening 140 in a glass core 130 with a layer of an electrically conductive material 144 on sidewalls of the opening 140 forms a horn antenna. Individual glass-based horn antenna units 106 may then be formed by cutting the glass core 130 with multiple openings 140 lined with the electrically conductive material 144 into separate units, a process that may be referred to as “singulation” of the glass core 130. FIG. 7 illustrates that the assembly of FIG. 6 may be singulated so that the first opening 140-1 forms a first antenna unit 106-1 and the second opening 140-2 forms a second antenna unit 106-2. In some embodiments, after singulation, a total width 146 of the glass core 130 of a given antenna unit 106 may be between about 50 microns and 2000 microns, including all values and ranges therein, e.g., between about 100 and 1000 microns or between about 100 and 750 microns. An opening 140 is a through-glass via (TGV) in the glass core 130, extending between the first face 131-1 and the second face 131-2 of the glass core 130, having it's sidewalls lined with the electrically conductive material 144 and otherwise being filled with air or vacuum, or some other gaseous, liquid, or solid dielectric material.

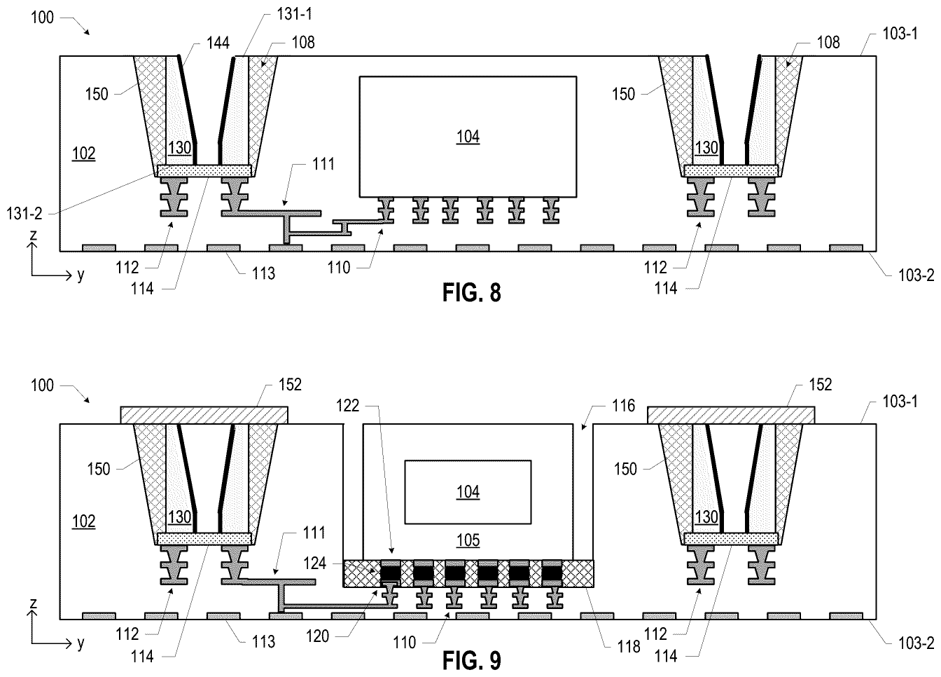

Antenna units 106 as shown in FIG. 7 may then be picked and placed into individual recesses 108 in the microelectronic component 102. FIGS. 8 and 9 illustrate microelectronic assemblies 100 substantially as shown in FIGS. 1 and 2, respectively, except that the antenna units 106 are now illustrated with the details of the antenna units 106 of FIG. 7. As shown in FIGS. 8 and 9, the second face 131-2 of the glass core may be placed on the bonding layer 114, so that the electrically conductive material 144 of the antenna units 106 is electrically connected to the interconnects 112, and other conductive pathways of the microelectronic component 102, via the bonding layer 114. FIGS. 8 and 9 illustrate that, in some embodiments, there may be gaps between the sidewalls of the antenna units 106 that are in the recesses 108 and the sidewalls of the recesses 108, where the gaps may be filled with a filler material 150. In some embodiments, the filler material 150 may be a dielectric, e.g., an epoxy. In some embodiments, an average width of a gap between the sidewalls of the antenna units 106 that are in the recesses 108 and the sidewalls of the recesses 108 (a dimension measured along the y-axis of the coordinate system shown) may be between about 1 micron and 200 microns, including all values and ranges therein, e.g., between about 1 and 50 microns or between about 10 and 50 microns. FIG. 9 illustrates that, in some embodiments, the openings 140 of the antenna units 106 may be covered with lids 152. For example, the lids 152 may include a glass material, e.g., any of the glass materials described with reference to the glass core 130. Glass-to-glass bonding may be used to mechanically attach one or more lids 152 to the glass cores 130 of the one or more antenna units 106. The lids 152 may then seal the air within the openings 140 of the antenna units 106. Although individual lids 152 are shown in FIG. 9 for different ones of the antenna units 106, in some embodiments, a single (i.e., a materially continuous) lid 152 may cover two or more antenna units 106. Although FIG. 8 does not illustrate the lids 152, one or more lids 152 may also be included there.

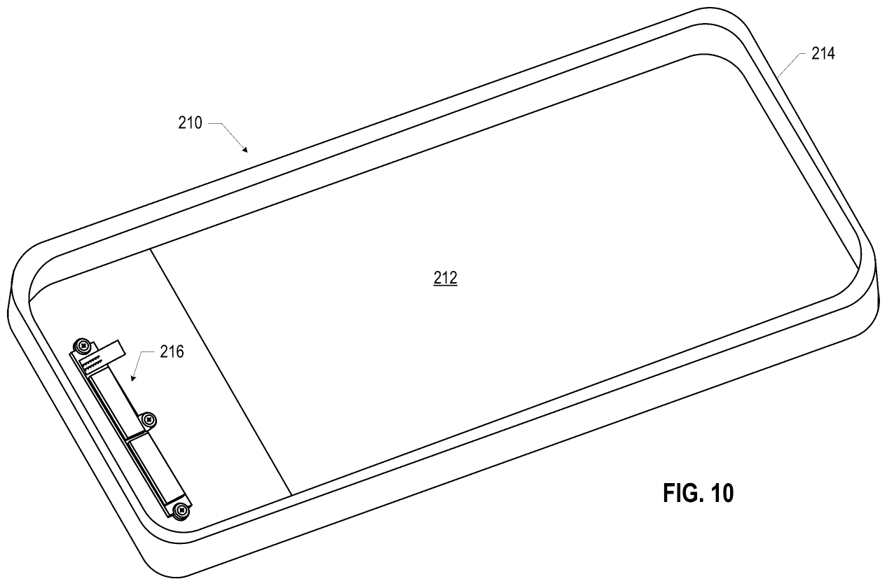

The microelectronic assemblies 100 disclosed herein may be included in any suitable communication device (e.g., a computing device with wireless communication capability, a wearable device with wireless communication circuitry, etc.). For example, FIG. 10 is a perspective view of a handheld communication device 210 including an IC package 216 that may include one or more microelectronic assemblies 100, in accordance with various embodiments. In particular, FIG. 10 depicts that the IC package 216 (and associated antenna board fixtures) may be coupled to a chassis 212 of the handheld communication device 210. A metal or plastic housing 214 may provide the “sides” of the communication device 210. In some embodiments, the handheld communication device 210 may be a smart phone.

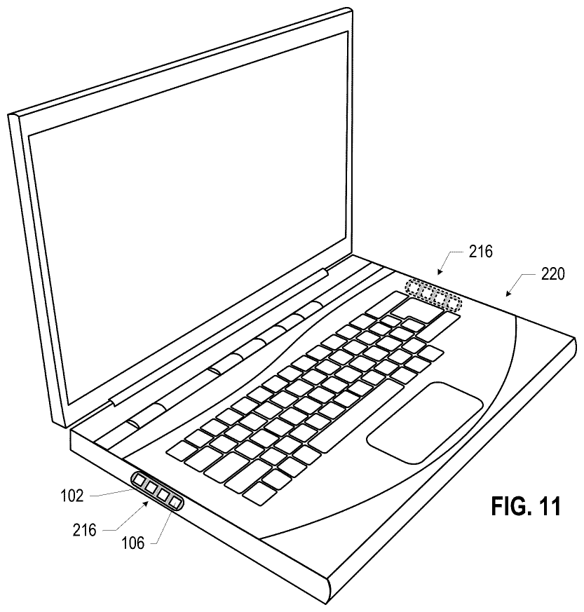

FIG. 11 is a perspective view of a laptop communication device 220 including multiple IC package 216, each including one or more microelectronic assemblies 100, in accordance with various embodiments. In particular, FIG. 11 depicts that IC packages 216, each having a microelectronic component 102 with four antenna units 106 in accordance with any of the embodiments described herein, are provided at either side of the keyboard of a laptop communication device 220. The antenna units 106 may occupy an area on the outside housing of the laptop communication device 220 that is approximately equal to or less than the area required for two adjacent Universal Serial Bus (USB) connectors (i.e., approximately 5 millimeters (height) by 22 millimeters (width) by 2.2 millimeters (depth)).

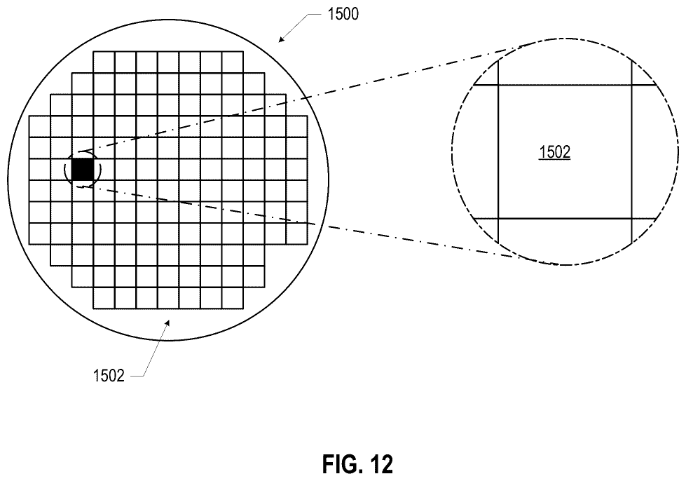

The microelectronic assemblies 100 disclosed herein may include, or be included in, any suitable electronic component. FIGS. 12-16 illustrate various examples of apparatuses that may include, or be included in, any of the microelectronic assemblies 100 disclosed herein.

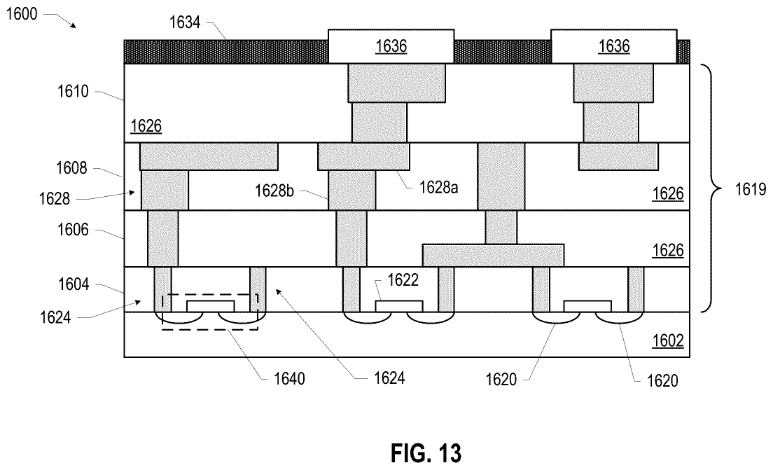

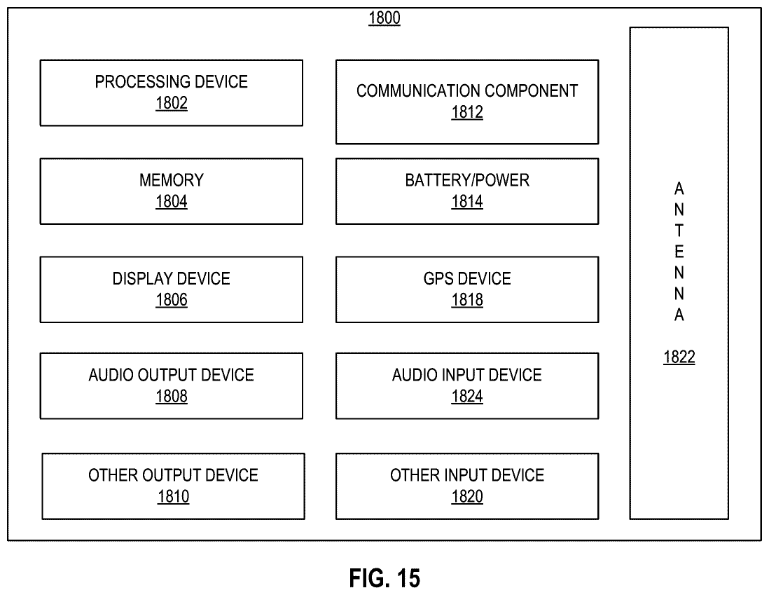

FIG. 12 is a top view of a wafer 1500 and dies 1502 that may be included in any of the microelectronic assemblies 100 disclosed herein. For example, a die 1502 may be the microelectronic component 102 of the microelectronic assembly 100 or may be a die on which circuitry 104 integrated with the microelectronic assembly 100 is provided. The die 1502 may be included in an IC package 216. The wafer 1500 may be composed of semiconductor material and may include one or more dies 1502 having IC structures formed on a surface of the wafer 1500. Each of the dies 1502 may be a repeating unit of a semiconductor product that includes any suitable IC. After the fabrication of the semiconductor product is complete, the wafer 1500 may undergo a singulation process in which the dies 1502 are separated from one another to provide discrete “chips” of the semiconductor product. The die 1502 may include one or more transistors (e.g., some of the transistors 1640 of FIG. 13, discussed below) and/or supporting circuitry to route electrical signals to the transistors, as well as any other IC components. In some embodiments, the wafer 1500 or the die 1502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1502. For example, a memory array formed by multiple memory devices may be formed on a same die 1502 as a processing device (e.g., the processing device 1802 of FIG. 15) or other logic that is configured to store information in the memory devices or execute instructions stored in the memory array.

FIG. 13 is a side, cross-sectional view of an IC device 1600 that may be included in any of the microelectronic assemblies 100 disclosed herein. For example, an IC device 1600 may be included in the circuitry 104 integrated with the microelectronic assembly 100, and/or an IC device 1600 may be included in an IC package 216. The IC device 1600 may be formed on a substrate 1602 (e.g., the wafer 1500 of FIG. 12) and may be included in a die (e.g., the die 1502 of FIG. 12). The substrate 1602 may be a semiconductor substrate composed of semiconductor material systems including, for example, n-type or p-type materials systems (or a combination of both). The substrate 1602 may include, for example, a crystalline substrate formed using a bulk silicon or a silicon-on-insulator (SOI) substructure. In some embodiments, the substrate 1602 may be formed using alternative materials, which may or may not be combined with silicon, that include but are not limited to germanium, indium antimonide, lead telluride, indium arsenide, indium phosphide, gallium arsenide, or gallium antimonide. Further materials classified as group II-VI, III-V, or IV may also be used to form the substrate 1602. Although a few examples of materials from which the substrate 1602 may be formed are described here, any material that may serve as a foundation for an IC device 1600 may be used. The substrate 1602 may be part of a singulated die (e.g., the dies 1502 of FIG. 12) or a wafer (e.g., the wafer 1500 of FIG. 12).

The IC device 1600 may include one or more device layers 1604 disposed on the substrate 1602. The device layer 1604 may include features of one or more transistors 1640 (e.g., metal oxide semiconductor field-effect transistors (MOSFETs)) formed on the substrate 1602. The device layer 1604 may include, for example, one or more source and/or drain (S/D) regions 1620, a gate 1622 to control current flow in the transistors 1640 between the S/D regions 1620, and one or more S/D contacts 1624 to route electrical signals to/from the S/D regions 1620. The transistors 1640 may include additional features not depicted for the sake of clarity, such as device isolation regions, gate contacts, and the like. The transistors 1640 are not limited to the type and configuration depicted in FIG. 13 and may include a wide variety of other types and configurations such as, for example, planar transistors, non-planar transistors, or a combination of both. Planar transistors may include bipolar junction transistors (BJT), heterojunction bipolar transistors (HBT), or high-electron-mobility transistors (HEMT). Non-planar transistors may include FinFET transistors, such as double-gate transistors or tri-gate transistors, and wrap-around or all-around gate transistors, such as nanoribbon and nanowire transistors.

Each transistor 1640 may include a gate 1622 formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer. For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1640 along the source-channel-drain direction, the gate electrode may consist of a U-shaped structure that includes a bottom portion substantially parallel to the surface of the substrate and two sidewall portions that are substantially perpendicular to the top surface of the substrate. In other embodiments, at least one of the metal layers that form the gate electrode may simply be a planar layer that is substantially parallel to the top surface of the substrate and does not include sidewall portions substantially perpendicular to the top surface of the substrate. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1620 may be formed within the substrate 1602 adjacent to the gate 1622 of each transistor 1640. The S/D regions 1620 may be formed using an implantation/diffusion process or an etching/deposition process, for example. In the former process, dopants such as boron, aluminum, antimony, phosphorous, or arsenic may be ion-implanted into the substrate 1602 to form the S/D regions 1620. An annealing process that activates the dopants and causes them to diffuse farther into the substrate 1602 may follow the ion-implantation process. In the latter process, the substrate 1602 may first be etched to form recesses at the locations of the S/D regions 1620. An epitaxial deposition process may then be carried out to fill the recesses with material that is used to fabricate the S/D regions 1620. In some implementations, the S/D regions 1620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1620 may be formed using one or more alternate semiconductor materials such as germanium or a group III-V material or alloy. In further embodiments, one or more layers of metal and/or metal alloys may be used to form the S/D regions 1620.

Electrical signals, such as power and/or input/output (I/O) signals, may be routed to and/or from the devices (e.g., the transistors 1640) of the device layer 1604 through one or more interconnect layers disposed on the device layer 1604 (illustrated in FIG. 13 as interconnect layers 1606-1610). For example, electrically conductive features of the device layer 1604 (e.g., the gate 1622 and the S/D contacts 1624) may be electrically coupled with the interconnect structures 1628 of the interconnect layers 1606-1610. The one or more interconnect layers 1606-1610 may form a metallization stack (also referred to as an “ILD stack”) 1619 of the IC device 1600.

The interconnect structures 1628 may be arranged within the interconnect layers 1606-1610 to route electrical signals according to a wide variety of designs (in particular, the arrangement is not limited to the particular configuration of interconnect structures 1628 depicted in FIG. 13). Although a particular number of interconnect layers 1606-1610 is depicted in FIG. 13, embodiments of the present disclosure include IC devices having more or fewer interconnect layers than depicted.

In some embodiments, the interconnect structures 1628 may include lines 1628a and/or vias 1628b filled with an electrically conductive material such as a metal. The lines 1628a may be arranged to route electrical signals in a direction of a plane that is substantially parallel with a surface of the substrate 1602 upon which the device layer 1604 is formed. For example, the lines 1628a may route electrical signals in a direction in and out of the page from the perspective of FIG. 13. The vias 1628b may be arranged to route electrical signals in a direction of a plane that is substantially perpendicular to the surface of the substrate 1602 upon which the device layer 1604 is formed. In some embodiments, the vias 1628b may electrically couple lines 1628a of different interconnect layers 1606-1610 together.

The interconnect layers 1606-1610 may include a dielectric material 1626 disposed between the interconnect structures 1628, as shown in FIG. 13. In some embodiments, the dielectric material 1626 disposed between the interconnect structures 1628 in different ones of the interconnect layers 1606-1610 may have different compositions; in other embodiments, the composition of the dielectric material 1626 between different interconnect layers 1606-1610 may be the same.

A first interconnect layer 1606 may be formed above the device layer 1604. In some embodiments, the first interconnect layer 1606 may include lines 1628a and/or vias 1628b, as shown. The lines 1628a of the first interconnect layer 1606 may be coupled with contacts (e.g., the S/D contacts 1624) of the device layer 1604.

A second interconnect layer 1608 may be formed above the first interconnect layer 1606. In some embodiments, the second interconnect layer 1608 may include vias 1628b to couple the lines 1628a of the second interconnect layer 1608 with the lines 1628a of the first interconnect layer 1606. Although the lines 1628a and the vias 1628b are structurally delineated with a line within each interconnect layer (e.g., within the second interconnect layer 1608) for the sake of clarity, the lines 1628a and the vias 1628b may be structurally and/or materially contiguous (e.g., simultaneously filled during a dual-damascene process) in some embodiments.

A third interconnect layer 1610 (and additional interconnect layers, as desired) may be formed in succession on the second interconnect layer 1608 according to similar techniques and configurations described in connection with the second interconnect layer 1608 or the first interconnect layer 1606. In some embodiments, the interconnect layers that are “higher up” in the metallization stack 1619 in the IC device 1600 (i.e., farther away from the device layer 1604) may be thicker.

The IC device 1600 may include a solder resist material 1634 (e.g., polyimide or similar material) and one or more conductive contacts 1636 formed on the interconnect layers 1606-1610. In FIG. 13, the conductive contacts 1636 are illustrated as taking the form of bond pads. The conductive contacts 1636 may be electrically coupled with the interconnect structures 1628 and configured to route the electrical signals of the transistor(s) 1640 to other external devices. For example, solder bonds may be formed on the one or more conductive contacts 1636 to mechanically and/or electrically couple a chip including the IC device 1600 with another component (e.g., a circuit board). The IC device 1600 may include additional or alternate structures to route the electrical signals from the interconnect layers 1606-1610; for example, the conductive contacts 1636 may include other analogous features (e.g., posts) that route the electrical signals to external components.

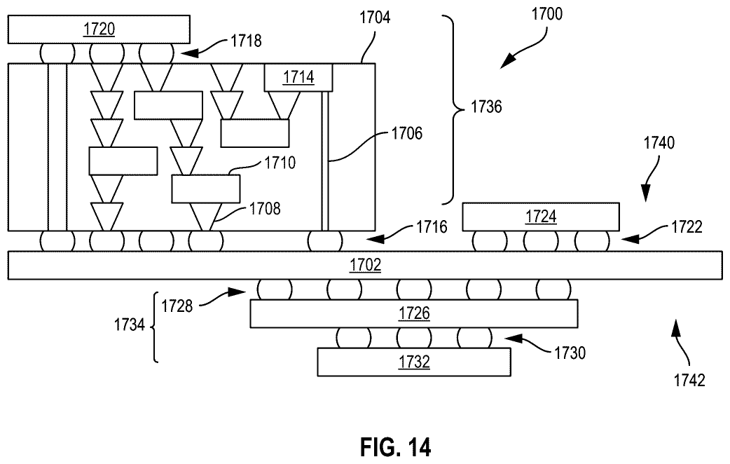

FIG. 14 is a side, cross-sectional view of an IC device assembly 1700 that may include one or more of the microelectronic assemblies 100 disclosed herein. In particular, any suitable ones of the microelectronic assemblies 100 disclosed herein may take the place of any of the components of the IC device assembly 1700 (e.g., a microelectronic assembly 100 may take the place of any of the IC packages of the IC device assembly 1700).

The IC device assembly 1700 includes a number of components disposed on a circuit board 1702 (which may be, e.g., a motherboard). The IC device assembly 1700 includes components disposed on a first face 1740 of the circuit board 1702 and an opposing second face 1742 of the circuit board 1702; generally, components may be disposed on one or both faces 1740 and 1742.

In some embodiments, the circuit board 1702 may be a PCB including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 1702. In other embodiments, the circuit board 1702 may be a non-PCB substrate.

The IC device assembly 1700 illustrated in FIG. 14 includes a package-on-interposer structure 1736 coupled to the first face 1740 of the circuit board 1702 by coupling components 1716. The coupling components 1716 may electrically and mechanically couple the package-on-interposer structure 1736 to the circuit board 1702, and may include solder balls (as shown in FIG. 14), male and female portions of a socket, an adhesive, an underfill material, and/or any other suitable electrical and/or mechanical coupling structure.

The package-on-interposer structure 1736 may include an IC package 1720 coupled to an interposer 1704 by coupling components 1718. The coupling components 1718 may take any suitable form for the application, such as the forms discussed above with reference to the coupling components 1716. Although a single IC package 1720 is shown in FIG. 14, multiple IC packages may be coupled to the interposer 1704; indeed, additional interposers may be coupled to the interposer 1704. The interposer 1704 may provide an intervening substrate used to bridge the circuit board 1702 and the IC package 1720. The IC package 1720 may be or include, for example, a die (the die 1502 of FIG. 12), an IC device (e.g., the IC device 1600 of FIG. 13), or any other suitable component. Generally, the interposer 1704 may spread a connection to a wider pitch or reroute a connection to a different connection. For example, the interposer 1704 may couple the IC package 1720 (e.g., a die) to a set of ball grid array (BGA) conductive contacts of the coupling components 1716 for coupling to the circuit board 1702. In the embodiment illustrated in FIG. 14, the IC package 1720 and the circuit board 1702 are attached to opposing sides of the interposer 1704; in other embodiments, the IC package 1720 and the circuit board 1702 may be attached to a same side of the interposer 1704. In some embodiments, three or more components may be interconnected by way of the interposer 1704.

In some embodiments, the interposer 1704 may be formed as a PCB, including multiple metal layers separated from one another by layers of dielectric material and interconnected by electrically conductive vias. In some embodiments, the interposer 1704 may be formed of an epoxy resin, a fiberglass-reinforced epoxy resin, an epoxy resin with inorganic fillers, a ceramic material, or a polymer material such as polyimide. In some embodiments, the interposer 1704 may be formed of alternate rigid or flexible materials that may include the same materials described above for use in a semiconductor substrate, such as silicon, germanium, and other group III-V and group IV materials. The interposer 1704 may include metal interconnects 1708 and vias 1710, including but not limited to through-silicon vias (TSVs) 1706. The interposer 1704 may further include embedded devices 1714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as RF devices, power amplifiers, power management devices, antennas, arrays, sensors, and microelectromechanical systems (MEMS) devices may also be formed on the interposer 1704. The package-on-interposer structure 1736 may take the form of any of the package-on-interposer structures known in the art.

The IC device assembly 1700 may include an IC package 1724 coupled to the first face 1740 of the circuit board 1702 by coupling components 1722. The coupling components 1722 may take the form of any of the embodiments discussed above with reference to the coupling components 1716, and the IC package 1724 may take the form of any of the embodiments discussed above with reference to the IC package 1720. In some embodiments, each of two or more of the IC packages 1724 and/or the IC packages 1720 may include the microelectronic assembly 100 as described herein, so that these IC packages may exchange data with one another wirelessly, using the antenna units 106 of their microelectronic assemblies, thus realizing chip-to-chip RF wireless communication.

The IC device assembly 1700 illustrated in FIG. 14 includes a package-on-package structure 1734 coupled to the second face 1742 of the circuit board 1702 by coupling components 1728. The package-on-package structure 1734 may include an IC package 1726 and an IC package 1732 coupled together by coupling components 1730 such that the IC package 1726 is disposed between the circuit board 1702 and the IC package 1732. The coupling components 1728 and 1730 may take the form of any of the embodiments of the coupling components 1716 discussed above, and the IC packages 1726 and 1732 may take the form of any of the embodiments of the IC package 1720 discussed above. The package-on-package structure 1734 may be configured in accordance with any of the package-on-package structures known in the art.

FIG. 15 is a block diagram of an example communication device 1800 that may include one or more microelectronic assemblies 100 in accordance with any of the embodiments disclosed herein. For example, any suitable ones of the components of the communication device 1800 except for the antenna 1822 may be included in circuitry 104 of a microelectronic assembly 100 as described herein, while the antenna 1822 of the communication device 1800 may be implemented as the antenna units 106 of a microelectronic assembly 100 as described herein. In another example, in some embodiments, one or more microelectronic assemblies 100 as described herein may be included in an antenna 1822 of the communication device 1800. The handheld communication device 210 (FIG. 10), and the laptop communication device 220 (FIG. 11) may be examples of the communication device 1800. Any suitable ones of the components of the communication device 1800 may include one or more of the IC packages 1650, IC devices 1600, or dies 1502 disclosed herein. A number of components are illustrated in FIG. 15 as included in the communication device 1800, but any one or more of these components may be omitted or duplicated, as suitable for the application. In some embodiments, some or all of the components included in the communication device 1800 may be attached to one or more motherboards. In some embodiments, some or all of these components are fabricated onto a single system-on-a-chip (SoC) die.

Additionally, in various embodiments, the communication device 1800 may not include one or more of the components illustrated in FIG. 15, but the communication device 1800 may include interface circuitry for coupling to the one or more components. For example, the communication device 1800 may not include a display device 1806, but may include display device interface circuitry (e.g., a connector and driver circuitry) to which a display device 1806 may be coupled. In another set of examples, the communication device 1800 may not include an audio input device 1824 or an audio output device 1808, but may include audio input or output device interface circuitry (e.g., connectors and supporting circuitry) to which an audio input device 1824 or audio output device 1808 may be coupled.

The communication device 1800 may include a processing device 1802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1802 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. The communication device 1800 may include a memory 1804, which may itself include one or more memory devices such as volatile memory (e.g., dynamic RAM (DRAM)), nonvolatile memory (e.g., read-only memory (ROM)), flash memory, solid state memory, and/or a hard drive. In some embodiments, the memory 1804 may include memory that shares a die with the processing device 1802. This memory may be used as cache memory and may include embedded dynamic RAM (eDRAM) or spin transfer torque magnetic RAM (STT-MRAM).

In some embodiments, the communication device 1800 may include a communication module 1812 (e.g., one or more communication modules). For example, the communication module 1812 may be configured for managing wireless communications for the transfer of data to and from the communication device 1800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication module 1812 may be, or may include, the circuitry 104 of the microelectronic assemblies 100 disclosed herein.

The communication module 1812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication module 1812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication module 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication module 1812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication module 1812 may operate in accordance with other wireless protocols in other embodiments. The communication device 1800 may include an antenna 1822 to facilitate wireless communications and/or to receive other wireless communications (such as AM or FM radio transmissions).

In some embodiments, the communication module 1812 may manage wired communications, such as electrical, optical, or any other suitable communication protocols (e.g., the Ethernet). As noted above, the communication module 1812 may include multiple communication modules. For instance, a first communication module 1812 may be dedicated to shorter-range wireless communications such as Wi-Fi or Bluetooth, and a second communication module 1812 may be dedicated to longer-range wireless communications such as global positioning system (GPS), EDGE, GPRS, CDMA, WiMAX, LTE, EV-DO, or others. In some embodiments, a first communication module 1812 may be dedicated to wireless communications, and a second communication module 1812 may be dedicated to wired communications. In some embodiments, the communication module 1812 may include circuitry that supports millimeter-wave communication.

The communication device 1800 may include battery/power circuitry 1814. The battery/power circuitry 1814 may include one or more energy storage devices (e.g., batteries or capacitors) and/or circuitry for coupling components of the communication device 1800 to an energy source separate from the communication device 1800 (e.g., AC line power).

The communication device 1800 may include a display device 1806 (or corresponding interface circuitry, as discussed above). The display device 1806 may include any visual indicators, such as a heads-up display, a computer monitor, a projector, a touchscreen display, a liquid crystal display (LCD), a light-emitting diode display, or a flat panel display.

The communication device 1800 may include an audio output device 1808 (or corresponding interface circuitry, as discussed above). The audio output device 1808 may include any device that generates an audible indicator, such as speakers, headsets, or earbuds.

The communication device 1800 may include an audio input device 1824 (or corresponding interface circuitry, as discussed above). The audio input device 1824 may include any device that generates a signal representative of a sound, such as microphones, microphone arrays, or digital instruments (e.g., instruments having a musical instrument digital interface (MIDI) output).

The communication device 1800 may include a GPS device 1818 (or corresponding interface circuitry, as discussed above). The GPS device 1818 may be in communication with a satellite-based system and may receive a location of the communication device 1800, as known in the art.

The communication device 1800 may include an other output device 1810 (or corresponding interface circuitry, as discussed above). Examples of the other output device 1810 may include an audio codec, a video codec, a printer, a wired or wireless transmitter for providing information to other devices, or an additional storage device.

The communication device 1800 may include an other input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The communication device 1800 may have any desired form factor, such as a handheld or mobile communication device (e.g., a cell phone, a smart phone, a mobile internet device, a music player, a tablet computer, a laptop computer, a netbook computer, an ultrabook computer, a personal digital assistant (PDA), an ultra mobile personal computer, etc.), a desktop communication device, a server or other networked computing component, a printer, a scanner, a monitor, a set-top box, an entertainment control unit, a vehicle control unit, a digital camera, a digital video recorder, or a wearable communication device. In some embodiments, the communication device 1800 may be any other electronic device that processes data.

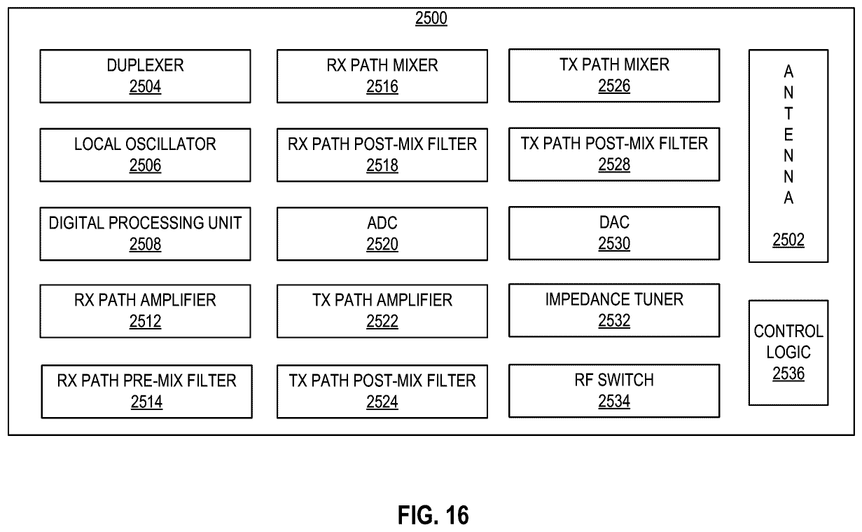

FIG. 16 is a block diagram of an example RF device 2500 that may include one or more microelectronic assemblies 100 in accordance with any of the embodiments disclosed herein. For example, any suitable ones of the components of the RF device 2500 except for the antenna 2502 may be included in circuitry 104 of a microelectronic assembly 100 as described herein, while the antenna 2502 of the RF device 2500 may be implemented as the antenna units 106 of a microelectronic assembly 100 as described herein. In another example, in some embodiments, one or more microelectronic assemblies 100 as described herein may be included in an antenna 2502 of the RF device 2500. Any of the components of the RF device 2500 may include, or be included in, an IC assembly 1700 as described with reference to FIG. 14. In some embodiments, the RF device 2500 may be included within any components of the computing device 1800 as described above with reference to FIG. 15 (e.g., the communication component 1812), or may be coupled to any of the components of the electrical device 1800 (e.g., may be coupled to the memory 1804 and/or to the processing device 1802 of the electrical device 1800). In still other embodiments, the RF device 2500 may further include any of the components described above with reference to FIG. 15, such as, but not limited to, the battery/power circuitry 1814, the memory 1804, and various input and output devices as discussed above with reference to FIG. 15.

In general, the RF device 2500 may be any device or system that may support wireless transmission and/or reception of signals in the form of electromagnetic waves in the RF range of approximately 3 kiloHertz (kHz) to 300 gigaHertz (GHz) and beyond. In some embodiments, the RF device 2500 may be used for wireless communications, e.g., in a base station (BS) or a user equipment (UE) device of any suitable cellular wireless communications technology, such as GSM, WCDMA, or LTE. In a further example, the RF device 2500 may be used as, or in, a BS or a UE device of a millimeter-wave wireless technology such as fifth generation (5G) wireless (e.g., high-frequency/short wavelength spectrum, with frequencies in the range between about 20 and 60 GHZ, corresponding to wavelengths in the range between about 5 and 15 millimeters). In yet another example, the RF device 2500 may be used for wireless communications using Wi-Fi technology (e.g., a frequency band of 2.4 GHZ, corresponding to a wavelength of about 12 cm, or a frequency band of 5.8 GHZ, corresponding to a wavelength of about 5 cm). For example, the RF device 2500 may be included in a Wi-Fi-enabled device such as a desktop, a laptop, a video game console, a smart phone, a tablet, a smart TV, a digital audio player, a car, a printer, etc. In some implementations, a Wi-Fi-enabled device may be a node (e.g., a smart sensor) in a smart system configured to communicate data with other nodes. In another example, the RF device 2500 may be used for wireless communications using Bluetooth technology (e.g., a frequency band from about 2.4 to about 2.485 GHZ, corresponding to a wavelength of about 12 cm). In other embodiments, the RF device 2500 may be used for transmitting and/or receiving RF signals for purposes other than communication (e.g., in an automotive radar system, or in medical applications such as magnetic resonance imaging (MRI)).

In various embodiments, the RF device 2500 may be included in frequency-division duplex (FDD) or time-domain duplex (TDD) variants of frequency allocations that may be used in a cellular network. In an FDD system, the uplink (i.e., RF signals transmitted from the UE devices to a BS) and the downlink (i.e., RF signals transmitted from the BS to the US devices) may use separate frequency bands at the same time. In a TDD system, the uplink and the downlink may use the same frequencies but at different times.

A number of components are illustrated in FIG. 16 as included in the RF device 2500, but any one or more of these components may be omitted or duplicated, as suitable for the application. For example, in some embodiments, the RF device 2500 may be an RF device supporting both of wireless transmission and reception of RF signals (e.g., an RF transceiver), in which case it may include both the components of what is referred to herein as a transmit (TX) path and the components of what is referred to herein as a receive (RX) path. However, in other embodiments, the RF device 2500 may be an RF device supporting only wireless reception (e.g., an RF receiver), in which case it may include the components of the RX path, but not the components of the TX path; or the RF device 2500 may be an RF device supporting only wireless transmission (e.g., an RF transmitter), in which case it may include the components of the TX path, but not the components of the RX path.

In some embodiments, some or all of the components included in the RF device 2500 may be attached to one or more motherboards. In various embodiments, the RF device 2500 may not include one or more of the components illustrated in FIG. 16, but the RF device 2500 may include interface circuitry for coupling to the one or more components. For example, the RF device 2500 may not include an antenna 2502, but may include antenna interface circuitry (e.g., a matching circuitry, a connector and driver circuitry) to which an antenna 2502 may be coupled. In another set of examples, the RF device 2500 may not include a digital processing unit 2508 or a local oscillator 2506, but may include device interface circuitry (e.g., connectors and supporting circuitry) to which a digital processing unit 2508 or a local oscillator 2506 may be coupled.

As shown in FIG. 16, the RF device 2500 may include an antenna 2502, a duplexer 2504, a local oscillator 2506, and a digital processing unit 2508. As also shown in FIG. 16, the RF device 2500 may include an RX path that may include an RX path amplifier 2512, an RX path pre-mix filter 2514, a RX path mixer 2516, an RX path post-mix filter 2518, and an analog-to-digital converter (ADC) 2520. As further shown in FIG. 16, the RF device 2500 may include a TX path that may include a TX path amplifier 2522, a TX path post-mix filter 2524, a TX path mixer 2526, a TX path pre-mix filter 2528, and a digital-to-analog converter (DAC) 2530. Still further, the RF device 2500 may further include an impedance tuner 2532, an RF switch 2534, and control logic 2536. In various embodiments, the RF device 2500 may include multiple instances of any of the components shown in FIG. 16. In some embodiments, the RX path amplifier 2512, the TX path amplifier 2522, the duplexer 2504, and the RF switch 2534 may be considered to form, or be a part of, an RF front-end (FE) of the RF device 2500. In some embodiments, the RX path amplifier 2512, the TX path amplifier 2522, the duplexer 2504, and the RF switch 2534 may be considered to form, or be a part of, an RF FE of the RF device 2500. In some embodiments, the RX path mixer 2516 and the TX path mixer 2526 (possibly with their associated pre-mix and post-mix filters shown in FIG. 16) may be considered to form, or be a part of, an RF transceiver of the RF device 2500 (or of an RF receiver or an RF transmitter if only RX path or TX path components, respectively, are included in the RF device 2500). In some embodiments, the RF device 2500 may further include one or more control logic elements/circuits, shown in FIG. 16 as control logic 2536 (providing, for example, an RF FE control interface). The control logic 2536 may be used to enhance control of complex RF system environment, support implementation of envelope tracking techniques, reduce dissipated power, etc.

The antenna 2502 may be configured to wirelessly transmit and/or receive RF signals in accordance with any wireless standards or protocols, e.g., Wi-Fi, LTE, or GSM, as well as any other wireless protocols that are designated as 3G, 4G, 5G, and beyond. If the RF device 2500 is an FDD transceiver, the antenna 2502 may be configured for concurrent reception and transmission of communication signals in separate, e.g., non-overlapping and non-continuous, bands of frequencies, e.g., in bands having a separation of, e.g., 20 MHz from one another. If the RF device 2500 is a TDD transceiver, the antenna 2502 may be configured for sequential reception and transmission of communication signals in bands of frequencies that may be the same or overlapping for TX and RX paths. In some embodiments, the RF device 2500 may be a multi-band RF device, in which case the antenna 2502 may be configured for concurrent reception of signals having multiple RF components in separate frequency bands and/or configured for concurrent transmission of signals having multiple RF components in separate frequency bands. In such embodiments, the antenna 2502 may be a single wide-band antenna or a plurality of band-specific antennas (e.g., a plurality of antennas each configured to receive and/or transmit signals in a specific band of frequencies). In various embodiments, the antenna 2502 may include a plurality of antenna elements, e.g., a plurality of antenna elements forming a phased antenna array (i.e., a communication system or an array of antennas that may use a plurality of antenna elements and phase shifting to transmit and receive RF signals). Compared to a single-antenna system, a phased antenna array may offer advantages such as increased gain, ability of directional steering, and simultaneous communication. In some embodiments, the RF device 2500 may include more than one antenna 2502 to implement antenna diversity. In some such embodiments, the RF switch 2534 may be deployed to switch between different antennas.

An output of the antenna 2502 may be coupled to the input of the duplexer 2504. The duplexer 2504 may be any suitable component configured for filtering multiple signals to allow for bidirectional communication over a single path between the duplexer 2504 and the antenna 2502. The duplexer 2504 may be configured for providing RX signals to the RX path of the RF device 2500 and for receiving TX signals from the TX path of the RF device 2500.

The RF device 2500 may include one or more local oscillators 2506, configured to provide local oscillator signals that may be used for downconversion of the RF signals received by the antenna 2502 and/or upconversion of the signals to be transmitted by the antenna 2502.

The RF device 2500 may include the digital processing unit 2508, which may include one or more processing devices. In some embodiments, the digital processing unit 2508 may be implemented as the processing device 1802 of FIG. 15, descriptions of which are provided above. The digital processing unit 2508 may be configured to perform various functions related to digital processing of the RX and/or TX signals. Examples of such functions include, but are not limited to, decimation/downsampling, error correction, digital downconversion or upconversion, DC offset cancellation, automatic gain control, etc. Although not shown in FIG. 16, in some embodiments, the RF device 2500 may further include a memory device (e.g., the memory device 1804 described above with reference to FIG. 15) configured to cooperate with the digital processing unit 2508.

Turning to the details of the RX path that may be included in the RF device 2500, the RX path amplifier 2512 may include a low noise amplifier (LNA). An input of the RX path amplifier 2512 may be coupled to an antenna port (not shown) of the antenna 2502, e.g., via the duplexer 2504. The RX path amplifier 2512 may amplify the RF signals received by the antenna 2502.

An output of the RX path amplifier 2512 may be coupled to an input of the RX path pre-mix filter 2514, which may be a harmonic or band-pass (e.g., low-pass) filter, configured to filter received RF signals that have been amplified by the RX path amplifier 2512.

An output of the RX path pre-mix filter 2514 may be coupled to an input of the RX path mixer 2516, also referred to as a downconverter. The RX path mixer 2516 may include two inputs and one output. A first input may be configured to receive the RX signals, which may be current signals, indicative of the signals received by the antenna 2502 (e.g., the first input may receive the output of the RX path pre-mix filter 2514). A second input may be configured to receive local oscillator signals from one of the local oscillators 2506. The RX path mixer 2516 may then mix the signals received at its two inputs to generate a downconverted RX signal, provided at an output of the RX path mixer 2516. As used herein, downconversion refers to a process of mixing a received RF signal with a local oscillator signal to generate a signal of a lower frequency. In particular, the RX path mixer (e.g., downconverter) 2516 may be configured to generate the sum and/or the difference frequency at the output port when two input frequencies are provided at the two input ports. In some embodiments, the RF device 2500 may implement a direct-conversion receiver (DCR), also known as homodyne, synchrodyne, or zero-intermediate frequency (IF) receiver, in which case the RX path mixer 2516 may be configured to demodulate the incoming radio signals using local oscillator signals whose frequency is identical to, or very close to the carrier frequency of the radio signal. In other embodiments, the RF device 2500 may make use of downconversion to an IF. IFs may be used in superheterodyne radio receivers, in which a received RF signal is shifted to an IF, before the final detection of the information in the received signal is done. Conversion to an IF may be useful for several reasons. For example, when several stages of filters are used, they can all be set to a fixed frequency, which makes them easier to build and to tune. In some embodiments, the RX path mixer 2516 may include several such stages of IF conversion.

Although a single RX path mixer 2516 is shown in the RX path of FIG. 16, in some embodiments, the RX path mixer 2516 may be implemented as a quadrature downconverter, in which case it would include a first RX path mixer and a second RX path mixer. The first RX path mixer may be configured for performing downconversion to generate an in-phase (I) downconverted RX signal by mixing the RX signal received by the antenna 2502 and an in-phase component of the local oscillator signal provided by the local oscillator 2506. The second RX path mixer may be configured for performing downconversion to generate a quadrature (Q) downconverted RX signal by mixing the RX signal received by the antenna 2502 and a quadrature component of the local oscillator signal provided by the local oscillator 2506 (the quadrature component is a component that is offset, in phase, from the in-phase component of the local oscillator signal by 90 degrees). The output of the first RX path mixer may be provided to a I-signal path, and the output of the second RX path mixer may be provided to a Q-signal path, which may be substantially 90 degrees out of phase with the I-signal path.

The output of the RX path mixer 2516 may, optionally, be coupled to the RX path post-mix filter 2518, which may be low-pass filters. In case the RX path mixer 2516 is a quadrature mixer that implements the first and second mixers as described above, the in-phase and quadrature components provided at the outputs of the first and second mixers respectively may be coupled to respective individual first and second RX path post-mix filters included in the RX path post-mix filter 2518.

The ADC 2520 may be configured to convert the mixed RX signals from the RX path mixer 2516 from the analog to the digital domain. The ADC 2520 may be a quadrature ADC that, similar to the RX path mixer 2516, may include two ADCs, configured to digitize the downconverted RX path signals separated in in-phase and quadrature components. The output of the ADC 2520 may be provided to the digital processing unit 2508, configured to perform various functions related to digital processing of the RX signals so that information encoded in the RX signals can be extracted.

Turning to the details of the TX path that may be included in the RF device 2500, the digital signal to later be transmitted (TX signal) by the antenna 2502 may be provided, from the digital processing unit 2508, to the DAC 2530. Similar to the ADC 2520, the DAC 2530 may include two DACs, configured to convert, respectively, digital I- and Q-path TX signal components to analog form.

Optionally, the output of the DAC 2530 may be coupled to the TX path pre-mix filter 2528, which may be a band-pass (e.g., low-pass) filter (or a pair of band-pass, e.g., low-pass, filters, in case of quadrature processing) configured to filter out, from the analog TX signals output by the DAC 2530, the signal components outside of the desired band. The digital TX signals may then be provided to the TX path mixer 2526, which may also be referred to as an upconverter. Similar to the RX path mixer 2516, the TX path mixer 2526 may include a pair of TX path mixers, for in-phase and quadrature component mixing. Similar to the first and second RX path mixers that may be included in the RX path, each of the TX path mixers of the TX path mixer 2526 may include two inputs and one output. A first input may receive the TX signal components, converted to the analog form by the respective DAC 2530, which are to be upconverted to generate RF signals to be transmitted. The first TX path mixer may generate an in-phase (I) upconverted signal by mixing the TX signal component converted to analog form by the DAC 2530 with the in-phase component of the TX path local oscillator signal provided from the local oscillator 2506 (in various embodiments, the local oscillator 2506 may include a plurality of different local oscillators, or be configured to provide different local oscillator frequencies for the RX path mixer 2516 in the RX path and the TX path mixer 2526 in the TX path). The second TX path mixer may generate a quadrature phase (Q) upconverted signal by mixing the TX signal component converted to analog form by the DAC 2530 with the quadrature component of the TX path local oscillator signal. The output of the second TX path mixer may be added to the output of the first TX path mixer to create a real RF signal. A second input of each of the TX path mixers may be coupled the local oscillator 2506.

Optionally, the RF device 2500 may include the TX path post-mix filter 2524, configured to filter the output of the TX path mixer 2526.

As noted above, the TX path amplifier 2522 may be a power amplifier, configured to amplify the upconverted RF signal before providing it to the antenna 2502 for transmission.

In various embodiments, any of the RX path pre-mix filter 2514, the RX path post-mix filter 2518, the TX path post-mix filter 2524, and the TX path pre-mix filter 2528 may be implemented as RF filters. In some embodiments, each of such RF filters may include one or more resonators (e.g., AWRs, film bulk acoustic resonators (FBARs), Lamb wave resonators, and/or contour-wave resonators), arranged in any suitable manner (e.g., in a ladder configuration). In some embodiments, an RF filter may be implemented as a plurality of RF filters, or a filter bank. A filter bank may include a plurality of RF resonators that may be coupled to a switch (e. g., the RF switch 2534) configured to selectively switch any one of the plurality of RF resonators on and off (e.g., activate any one of the plurality of RF resonators), in order to achieve desired filtering characteristics of the filter bank (e.g., in order to program the filter bank). For example, such a filter bank may be used to switch between different RF frequency ranges when the RF device 2500 is, or is included in, a BS or in a UE device. In another example, such a filter bank may be programmable to suppress TX leakage on the different duplex distances.

The impedance tuner 2532 may include any suitable circuitry, configured to match the input and output impedances of the different RF circuitries to minimize signal losses in the RF device 2500. For example, the impedance tuner 2532 may include an antenna impedance tuner. Being able to tune the impedance of the antenna 2502 may be particularly advantageous because antenna's impedance is a function of the environment that the RF device 2500 is in, e.g., antenna's impedance changes depending on, e.g., if the antenna is held in a hand, placed on a car roof, etc.

As described above, the RF switch 2534 may be a device configured to route high-frequency signals through transmission paths in order to selectively switch between a plurality of instances of any one of the components shown in FIG. 16 (e.g., to achieve desired behavior and characteristics of the RF device 2500). In some embodiments, an RF switch 2534 may be used to switch between different antennas 2502. In other embodiments, an RF switch may be used to switch between a plurality of RF resonators (e.g., by selectively switching RF resonators on and off) of any of the filters included in the RF device 2500. Typically, an RF system may include a plurality of such RF switches.

The RF device 2500 provides a simplified version and, in further embodiments, other components not specifically shown in FIG. 16 may be included. For example, the RX path of the RF device 2500 may include a current-to-voltage amplifier between the RX path mixer 2516 and the ADC 2520, which may be configured to amplify and convert the downconverted signals to voltage signals. In another example, the RX path of the RF device 2500 may include a balun transformer for generating balanced signals. In yet another example, the RF device 2500 may further include a clock generator, which may include a suitable phase-lock loop (PLL), configured to receive a reference clock signal and use it to generate a different clock signal that may then be used for timing the operation of the ADC 2520, the DAC 2530, and/or that may also be used by the local oscillator 2506 to generate the local oscillator signals to be used in the RX path or the TX path.

The following paragraphs provide examples of various ones of the embodiments disclosed herein.

Example 1 provides a microelectronic assembly that includes a microelectronic component (e.g., a package substrate, a circuit board, and interposer, or a die) having a first face and an opposing second face, where the first face of the microelectronic component has a recess therein; and an antenna unit, where the antenna unit is at least partially in the recess and includes a glass core and an antenna integrated with/in the glass core. For example, the antenna unit includes a glass core (e.g., a glass layer, e.g., including bulk glass or a solid volume of glass) having a first face and an opposing second face, an opening extending between the first face and the second face of the glass core, where a width of the opening at the first face of the glass core is larger than a width of the opening at the second face of the glass core, and a layer of an electrically conductive material on sidewalls of the opening, where opening in the glass core lined with the layer of the electrically conductive material forms a horn antenna integrated in the glass core.

Example 2 provides the microelectronic assembly according to example 1, where the first face of the glass core is aligned with the first face of the microelectronic component.

Example 3 provides the microelectronic assembly according to examples 1 or 2, where the second face of the glass core is closer to the second face of the microelectronic component than the first face of the glass core.

Example 4 provides the microelectronic assembly according to any one of the preceding examples, where the opening with the layer of the electrically conductive material is filled with air.

Example 5 provides the microelectronic assembly according to any one of the preceding examples, further including a gap between at least a portion of the glass core that is within the recess and a sidewall of the recess.

Example 6 provides the microelectronic assembly according to example 5, further including a filler material in the gap.

Example 7 provides the microelectronic assembly according to example 6, where the filler material includes a dielectric.

Example 8 provides the microelectronic assembly according to example 6, where the filler material includes epoxy.

Example 9 provides the microelectronic assembly according to any one of examples 5-8, where the gap is between about 1 micron and 200 microns, including all values and ranges therein, e.g., between about 1 and 50 microns or between about 10 and 50 microns.

Example 10 provides the microelectronic assembly according to any one of the preceding examples, further including a lid covering the opening at the first face of the glass core.

Example 11 provides the microelectronic assembly according to example 10, where the lid includes glass.

Example 12 provides the microelectronic assembly according to examples 10 or 11, where the lid is bonded to the first face of the glass core.

Example 13 provides the microelectronic assembly according to any one of the preceding examples, where a dimension of the glass core in a plane perpendicular to the first face of the glass core (i.e., a height of the glass core) is between about 50 microns and 2000 microns, including all values and ranges therein, e.g., between about 100 and 1000 microns or between about 100 and 750 microns.

Example 14 provides the microelectronic assembly according to any one of the preceding examples, where a dimension of the glass core in a plane parallel to the first face of the glass core (i.e., a total width of the glass core, including the opening therein) is between about 50 microns and 2000 microns, including all values and ranges therein, e.g., between about 100 and 1000 microns or between about 100 and 750 microns.

Example 15 provides the microelectronic assembly according to any one of the preceding examples, where the width of the opening at the first face of the glass core is between about 50 microns and 2000 microns, including all values and ranges therein, e.g., between about 100 and 1000 microns or between about 100 and 750 microns.

Example 16 provides the microelectronic assembly according to any one of the preceding examples, where the width of the opening at the second face of the glass core is between about 10 microns and 200 microns, including all values and ranges therein, e.g., between about 10 and 100 microns or between about 10 and 75 microns.

Example 17 provides the microelectronic assembly according to any one of the preceding examples, where the layer of the electrically conductive material has a thickness between about 1 nanometer and 20 micron, including all values and ranges therein, e.g., between about 1 and 20 nanometers, between about 1 and 10 nanometers or between about 1 and 5 nanometers.

Example 18 provides the microelectronic assembly according to any one of the preceding examples, where the microelectronic component includes conductive pathways and the electrically conductive material on the sidewalls of the opening is coupled (e.g., directly connected) to one or more of the conductive pathways.

Example 19 provides the microelectronic assembly according to example 18, further including a bonding layer, where the conductive pathways of the microelectronic component are coupled to the electrically conductive material on the sidewalls of the opening via the bonding layer.

Example 20 provides the microelectronic assembly according to example 19, where the bonding layer includes a conductive material.

Example 21 provides the microelectronic assembly according to any one of the preceding examples, further including a die coupled to the microelectronic component.

Example 22 provides the microelectronic assembly according to example 21, where the die is coupled to the first face of the microelectronic component.

Example 23 provides the microelectronic assembly according to examples 21 or 22, where the recess is a first recess, the first face of the microelectronic component further has a second recess therein, and the die is at least partially in the second recess.

Example 24 provides the microelectronic assembly according to example 21, where the die is coupled to the second face of the microelectronic component.

Example 25 provides the microelectronic assembly according to examples 21 or 24, where the second face of the microelectronic component further has a recess therein, and the die is at least partially in the recess in the second face of the microelectronic component.

Example 26 provides the microelectronic assembly according to any one of examples 21-25, where the die includes circuitry to control operation of the antenna unit or circuitry for sending or receiving data using the antenna unit.

Example 27 provides the microelectronic assembly according to any one of examples 21-26, where the microelectronic component includes conductive pathways and the electrically conductive material on the sidewalls of the opening is coupled to the die via one or more of the conductive pathways.

Example 28 provides the microelectronic assembly according to any one of examples 1-28, where the microelectronic component is an interposer.

Example 29 provides the microelectronic assembly according to any one of examples 1-28, where the microelectronic component is a package substrate.

Example 30 provides the microelectronic assembly according to any one of examples 1-28, where the microelectronic component is a circuit board.

Example 31 provides an antenna unit that includes a glass core having a first face and a second face opposite the first face; a TGV extending between the first face and the second face of the glass core, where a width of the TGV at the first face of the glass core is larger than a width of the TGV at the second face of the glass core; and an electrically conductive material on sidewalls of the TGV.

Example 32 provides the antenna unit according to example 31, where the TGV is filled with air.

Example 33 provides the antenna unit according to examples 31 or 32, where the glass core includes ions of sodium or boron, e.g., to modulate mechanical or electrical properties of the glass core.

Example 34 provides the antenna unit according to any one of examples 31-33, where a dimension of the glass core in a plane perpendicular to the first face of the glass core (i.e., the height of the glass core) is between about 50 microns and 2000 microns, including all values and ranges therein, e.g., between about 100 and 1000 microns or between about 100 and 750 microns.

Example 35 provides the antenna unit according to any one of examples 31-34, where a dimension of the glass core in a plane parallel to the first face of the glass core (i.e., the total width of the glass core, including the opening therein) is between about 50 microns and 2000 microns, including all values and ranges therein, e.g., between about 100 and 1000 microns or between about 100 and 750 microns.

Example 36 provides the antenna unit according to any one of examples 31-35, where the width of the TGV at the first face of the glass core is between about 50 microns and 2000 microns, including all values and ranges therein, e.g., between about 100 and 1000 microns or between about 100 and 750 microns

Example 37 provides the antenna unit according to any one of examples 31-36, where the width of the TGV at the second face of the glass core is between about 10 microns and 200 microns, including all values and ranges therein, e.g., between about 10 and 100 microns or between about 10 and 75 microns.

Example 38 provides the antenna unit according to any one of examples 31-37, where the electrically conductive material has a thickness between about 1 and 20 nanometers, including all values and ranges therein, e.g., between about 1 and 10 nanometers or between about 1 and 5 nanometers.

Example 39 provides the antenna unit according to any one of examples 31-38, where the electrically conductive material includes copper, silver, nickel, gold, aluminum, titanium, or tantalum.

Example 40 provides the antenna unit according to any one of examples 31-39, where the antenna unit is a horn antenna.

Example 41 provides a method of manufacturing an IC package, the method including: forming a recess in a first face of an microelectronic component (e.g., a package substrate or a circuit board); and arranging an antenna unit at least partially in the recess, where the antenna unit includes a glass core and an antenna integrated with the glass core.

Example 42 provides the method according to example 41, where the recess is formed by laser drilling.

Example 43 provides the method according to examples 41 or 42, where the recess has a depth between about 10 microns and 500 microns.

Example 44 provides the method according to any one of examples 41-43, further including: filling a gap between sidewalls of the recess and a portion of the antenna unit that is in the recess with a solid filler material.

Example 45 provides the method according to example 44, where the filler material includes epoxy.

Example 46 provides the method according to examples 44 or 45, where the gap is between about 1 micron and 200 microns, including all values and ranges therein, e.g., between about 1 and 50 microns or between about 10 and 50 microns.

Example 47 provides the method according to any one of examples 41-46, further including: providing a lid over the antenna unit.

Example 48 provides the method according to example 47, where the lid is attached to the antenna unit by glass-to-glass bonding.

Example 49 provides the method according to any one of examples 41-48, where the antenna unit is electrically coupled to one or more conductive pathways in the microelectronic component.

Example 50 provides the method according to any one of examples 41-49, further including processes for providing the microelectronic assembly according to any one of the preceding examples.

Example 51 provides a system, including: a circuit board; and a microelectronic assembly, communicatively coupled to the circuit board, where the microelectronic assembly is a microelectronic assembly according to any one of the preceding examples.

Example 52 provides the system according to example 51, where the circuit board is a motherboard.

Example 53 provides the system according to examples 51 or 52, where the system further includes a display communicatively coupled to the circuit board.

Example 54 provides the system according to any one of examples 51-53, where the system is a handheld computing system.

Example 55 provides the system according to any one of examples 51-54, where the system is a wearable computing system.

Example 56 provides the system according to any one of examples 51-53, where the system is a server computing system.

Example 57 provides the system according to any one of examples 51-53, where the system is a vehicular computing system.

Example 58 provides the system according to any one of examples 51-57, where the system further includes a wireless communication device communicatively coupled to the circuit board.

Example 59 provides the system according to any one of examples 51-58, where the system further includes a housing around the microelectronic assembly and the circuit board.

Example 60 provides a communication device, including: a display; a back cover; and an IC package between the display and the back cover, where the IC package includes a microelectronic assembly according to any one of the preceding examples. The communication device of example 60 may include the system according to any one of examples 51-59, where the IC package includes the circuit board and the microelectronic assembly.

1. A microelectronic assembly, comprising:
a microelectronic component having a first face and a second face, wherein the first face of the microelectronic component has a recess therein; and
an antenna unit, wherein the antenna unit is at least partially in the recess and includes:
a glass layer having a first face and an opposing second face,
an opening extending between the first face and the second face of the glass layer, wherein a width of the opening at the first face of the glass layer is larger than a width of the opening at the second face of the glass layer, and
a layer of an electrically conductive material on sidewalls of the opening.

2. The microelectronic assembly according to claim 1, wherein the first face of the glass layer is aligned with the first face of the microelectronic component.

3. The microelectronic assembly according to claim 1, further comprising a gap between at least a portion of the glass layer that is within the recess and a sidewall of the recess.

4. The microelectronic assembly according to claim 3, further comprising a filler material in the gap.

5. The microelectronic assembly according to claim 3, wherein the gap is between about 1 micron and 200 microns.

6. The microelectronic assembly according to claim 1, further comprising a lid covering the opening at the first face of the glass layer.

7. The microelectronic assembly according to claim 6, wherein the lid includes glass.

8. The microelectronic assembly according to claim 1, wherein a height of the glass layer is between about 50 microns and 2000 microns or a width of the glass layer is between about 50 microns and 2000 microns.

9. The microelectronic assembly according to claim 1, wherein the layer of the electrically conductive material has a thickness between about 1 nanometer and 20 micron.

10. The microelectronic assembly according to claim 1, wherein the microelectronic component includes conductive pathways and the electrically conductive material is in conductive contact with one or more of the conductive pathways.

11. The microelectronic assembly according to claim 10, further comprising a bonding layer, wherein the conductive pathways of the microelectronic component are coupled to the electrically conductive material via the bonding layer.

12. The microelectronic assembly according to claim 1, further comprising a die coupled to the first face of the microelectronic component.

13. The microelectronic assembly according to claim 12, wherein:
the recess is a first recess,
the first face of the microelectronic component further has a second recess therein, and
the die is at least partially in the second recess.

14. The microelectronic assembly according to claim 12, wherein the die includes circuitry to control operation of the antenna unit or circuitry for sending or receiving data using the antenna unit.

15. The microelectronic assembly according to claim 12, wherein the microelectronic component includes conductive pathways and the electrically conductive material of the antenna unit is coupled to the die via one or more of the conductive pathways.

16. An antenna unit, comprising:
a glass core having a first face and a second face opposite the first face;
a through-glass-via (TGV) extending between the first face and the second face of the glass core, wherein a width of the TGV at the first face of the glass core is larger than a width of the TGV at the second face of the glass core; and
an electrically conductive material on sidewalls of the TGV.

17. The antenna unit according to claim 16, wherein the glass core includes ions of sodium or boron.

18. The antenna unit according to claim 16, wherein the antenna unit is a horn antenna.

19. A communication device, comprising:
a circuit board; and
a microelectronic assembly, communicatively coupled to the circuit board, wherein the microelectronic assembly includes an antenna unit comprising a glass core and a horn antenna integrated with the glass core.

20. The communication device according to claim 19, further comprising:
a display;
a back cover, and
an Integrated circuit (IC) package between the display and the back cover, wherein the IC package includes the circuit board and the microelectronic assembly.
